(19) United States
(12) Patent Application Publication
(10) Pub. No.: US 2020/0228346 A1
(43) Pub. Date: Jul. 16, 2020

(54) ENCRYPTED DATA GENERATION DEVICE, DIGITAL SIGNATURE GENERATION DEVICE, DIGITAL SIGNATURE-ATTACHED DATA GENERATION DEVICE, AND DIGITAL SIGNATURE-ATTACHED DATA GENERATION SYSTEM

(71) Applicants: Kabushiki Kaisha Toshiba, Tokyo (JP); Toshiba Electronic Devices & Storage Corporation, Tokyo (JP)

(72) Inventor: Hiromi Sakata, Suginami Tokyo (JP)

(21) Appl. No.: 16/287,139

(22) Filed: Feb. 27, 2019

(30) Foreign Application Priority Data
Jul. 31, 2018 (JP) 2018-144062

(51) Int. Cl. H04L 9/32; H04L 9/06; H04L 9/30

(52) U.S. Cl. CPC H04L 9/3247; H04L 9/30; H04L 9/0643

(57) ABSTRACT

According to the embodiment, an encrypted data generation device includes one or more processors. The one or more processors generate a first hash value from plaintext data by a certain hash function, encrypt the plaintext data, and generate encrypted data. And the one or more processors transmit the first hash value and the encrypted data to an external device.

### CROSS-REFERENCE TO RELATED APPLICATIONS

This application is based upon and claims the benefit of priority from Japanese Patent Application No. 2018-144062, filed on Jul. 31, 2018; the entire contents of which are incorporated herein by reference.

### FIELD

An embodiment described herein relates generally to an encrypted data generation device, a digital signature generation device, a digital signature-attached data generation device, and a digital signature-attached data generation system.

### BACKGROUND

Conventionally, a technique of generating a digital signature from a hash value that is obtained by inputting plaintext data into a hash function is known.

However, a device that generates the plaintext data and a device that generates the digital signature are sometimes different. Such a case gives rise to the need to avoid transfer of the plaintext data between the devices so as to prevent exposure of the plaintext data.

### BRIEF DESCRIPTION OF THE DRAWINGS

FIG. 1 is a diagram illustrating an example of an overall configuration of a digital signature-attached data generation system according to an embodiment;

FIG. 2 is a flowchart illustrating an example of a flow of an encrypted data generation process according to the embodiment;

FIG. 3 is a flowchart illustrating an example of a flow of a signature-attached data generation process according to the embodiment; and

FIG. 4 is a flowchart illustrating an example of a flow of a digital signature generation process according to the embodiment.

### DETAILED DESCRIPTION

According to the embodiment, an encrypted data generation device includes one or more processors. The one or more processors generate a first hash value from plaintext data by a certain hash function, encrypt the plaintext data, and generate encrypted data. And the one or more processors transmit the first hash value and the encrypted data to an external device.

Hereinafter, an encrypted data generation device, a digital signature generation device, a digital signature-attached data generation device, and a digital signature-attached data generation system according to the embodiment will be described in detail with reference to the appended drawings. Additionally, the present invention is not limited to the embodiment.

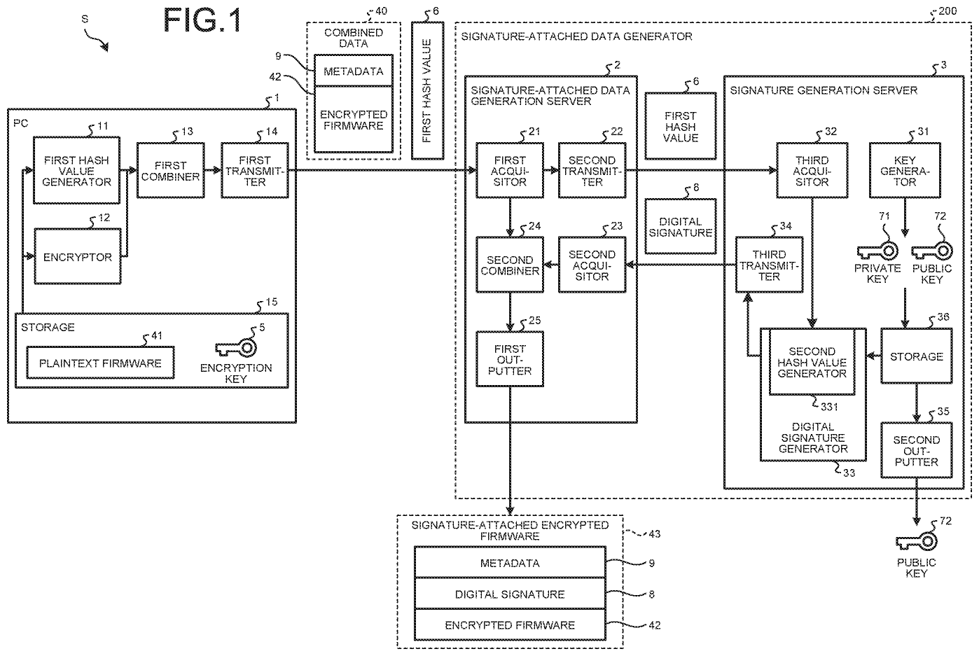

FIG. 1 is a diagram illustrating an example of an overall configuration of a digital signature-attached data generation system S according to the embodiment. The digital signature-attached data generation system S (hereinafter “signature-attached data generation system S”) of the embodiment includes a personal computer (PC) 1, a signature-attached data generation server 2, and a signature generation server 3. The signature-attached data generation server 2 and the signature generation server 3 are also collectively referred to as a signature-attached data generator 200. In the embodiment, a “signature” refers to a digital signature (electronic signature).

The PC 1, the signature-attached data generation server 2, and the signature generation server 3 each include a control device such as a CPU (processor), storage devices such as a read only memory (ROM) and a random access memory (RAM), and an external storage device such as a hard disk drive (HDD) or a flash memory, and have a hardware configuration that uses a normal computer. Furthermore, the PC 1, the signature-attached data generation server 2, and the signature generation server 3 are connected via a network such as a local area network (LAN).

The PC 1 includes a first hash value generator 11, an encryptor 12, a first combiner 13, a first transmitter 14, and a storage 15. The PC 1 is an example of the encrypted data generation device of the embodiment. The PC 1 is also referred to as an encrypted data generator of the signature-attached data generation system S.

The storage 15 stores plaintext firmware 41 and an encryption key 5. The storage 15 is a storage device such as an HDD or a flash memory, for example.

The plaintext firmware 41 is firmware for a hard disk device, which is to be used by a hard disk device outside the digital signature-attached data generation system S, and which is not encrypted. The plaintext firmware 41 is an example of plaintext data according to the embodiment.

The encryption key 5 is an encryption key of a common key system, and is assumed to be determined in advance.

The first hash value generator 11 generates a first hash value 6 from the plaintext firmware 41 by a certain hash function. Specifically, the first hash value generator 11 inputs the plaintext firmware 41 into a certain hash function, and calculates (generates) the first hash value 6. In the embodiment, the certain hash function is SHA-256, for example, but is not limited thereto.

The encryptor 12 encrypts the plaintext firmware 41 by the common key system by the encryption key 5, and generates encrypted firmware 42. The encrypted firmware 42 is an example of encrypted data according to the embodiment.

In the embodiment, the plaintext firmware 41 is encrypted by the common key system, and thus, the encryption key 5 is also used to decrypt signature-attached encrypted firmware 43 that is output from the signature-attached data generation server 2 described later. The encryption key 5 may be saved in advance in an external hard disk device, which is a download destination of the signature-attached encrypted firmware 43, or may be transmitted to the external hard disk device by means other than the signature-attached encrypted firmware 43. The encryption key 5 may be manually registered in the hard disk device by a user of the external hard disk device.

The first combiner 13 combines metadata 9 with the encrypted firmware 42. In the following, data that is obtained by combining the encrypted firmware 42 and the metadata 9 will be referred to as combined data 40. The metadata 9 is data including information about the encrypted firmware 42, and includes, for example, identification information allowing identification of the encrypted firmware 42 and information indicating presence/absence of a digital signature. At a time when the metadata 9 is combined by the first combiner 13, a digital signature is not added to the encrypted firmware 42, and thus, information indicating that a digital signature is not attached is included in the metadata 9. The metadata 9 may be saved in the storage 15 in advance, or may be generated by the first combiner 13.

Furthermore, the first combiner 13 determines whether a data length of the encrypted firmware 42 is a certain data length or not, and when determining that the data length of the encrypted firmware 42 is not the certain data length, the first combiner 13 adds, to the encrypted firmware 42, padding data for filling up a difference to the certain data length. For example, the certain data length is a multiple of a size of one sector (such as 512 bytes) of a hard disk. In the case where the data length of the encrypted firmware 42 is not a multiple of 512 bytes, the first combiner 13 adds padding data (such as “0”) so as to make a total data length of the encrypted firmware 42 and the padding data a multiple of 512 bytes. The first combiner 13 may also add, to the metadata 9, padding data for filling up a difference to a certain data length.

The first transmitter 14 transmits the first hash value 6 and the encrypted firmware 42 to the signature-attached data generation server 2. More specifically, the first transmitter 14 transmits the combined data 40 including the metadata 9 and the encrypted firmware 42 to which the padding data is added, and the first hash value 6 to the signature-attached data generation server 2.

The signature-attached data generation server 2 includes a first acquisitor 21, a second transmitter 22, a second acquisitor 23, a second combiner 24, and a first outputter 25. The signature-attached data generation server 2 is an example of the digital signature-attached data generation device and the external device according to the embodiment.

The first acquisitor 21 acquires the encrypted firmware 42 and the first hash value 6 from the PC 1. More specifically, the first acquisitor 21 acquires the combined data 40 including the encrypted firmware 42 and the metadata 9, and the first hash value 6.

The second transmitter 22 transmits the first hash value 6 acquired by the first acquisitor 21 to the signature generation server 3.

The second acquisitor 23 acquires a digital signature 8 generated by the signature generation server 3. The digital signature 8 is a digital signature for the plaintext firmware 41. Details of a method of generating the digital signature will be given later. In the case where the first acquisitor 21 and the second acquisitor 23 are not particularly distinguished from each other, a term “acquisitor” is simply used.

The second combiner 24 combines the digital signature 8, the encrypted firmware 42, and the metadata 9, and generates the signature-attached encrypted firmware 43.

The signature-attached encrypted firmware 43 of the embodiment includes the metadata 9, the digital signature 8, and the encrypted firmware 42. The signature-attached encrypted firmware 43 is an example of digital signature-attached encrypted data according to the embodiment.

Furthermore, the second combiner 24 updates contents of the metadata 9 before combining the metadata 9 with the encrypted firmware 42. For example, the second combiner 24 adds, to the metadata 9, information indicating that the encrypted firmware 42 includes the digital signature 8, and information for distinguishing between the digital signature 8 and the encrypted firmware 42 in the signature-attached encrypted firmware 43 (for example, information indicating description ranges of the digital signature 8 and the encrypted firmware 42 in the signature-attached encrypted firmware 43).

The first outputter 25 outputs the signature-attached encrypted firmware 43 that is generated by the second combiner 24. The output signature-attached encrypted firmware 43 is downloaded in the hard disk device through a network such as the Internet. The method of outputting the signature-attached encrypted firmware 43 is not limited thereto, and the first outputter 25 may save the signature-attached encrypted firmware 43 in a storage medium.

The signature generation server 3 includes a key generator 31, a third acquisitor 32, a digital signature generator 33, a third transmitter 34, a second outputter 35, and a storage 36. The signature generation server 3 is an example of the digital signature generation device according to the embodiment.

The key generator 31 generates a pair of private key 71 and public key 72, and saves the keys in the storage 36.

The third acquisitor 32 acquires the first hash value 6 from the signature-attached data generation server 2.

The digital signature generator 33 includes a second hash value generator 331. The second hash value generator 331 generates a second hash value from the first hash value 6 by a certain hash function. More specifically, the second hash value generator 331 inputs the first hash value 6 into a certain hash function, and calculates the second hash value. The hash function to be used by the second hash value generator 331 may be the same or different hash function from the one used by the first hash value generator 11 of the PC 1. Additionally, the second hash value generator 331 may be configured separately from the digital signature generator 33.

Furthermore, the digital signature generator 33 encrypts the second hash value with the private key 71 that is saved in the storage 36, and generates the digital signature 8 for the plaintext firmware 41. For example, the digital signature generator 33 generates the digital signature 8 by a known encryption algorithm such as RSASSA-PKCS1-v1_5.

The third transmitter 34 transmits the digital signature 8 that is generated by the digital signature generator 33 to the signature-attached data generation server 2.

The second outputter 35 outputs the public key 72 that is paired with the private key 71 that is used by the digital signature generator 33 to encrypt the second hash value. For example, the second outputter 35 transmits the public key 72 to the hard disk device through a network such as the Internet. The method of outputting the public key 72 is not limited thereto, and the second outputter 35 may save the public key 72 in a storage medium, or may publish the public key 72 on a network such as the Internet, for example. Alternatively, the public key 72 that is output by the second outputter 35 may be saved in advance in a hard disk device before shipping.

The storage 36 stores the private key 71 and the public key 72 that are generated by the key generator 31. The storage 36 is a tamper resistant storage device that is applied with circuit obfuscation or with protections against physical analysis, for example. A known technique may be used as a method of achieving tamper resistance.

Next, an encrypted data generation process by the PC 1 of the embodiment configured in the above manner will be described.

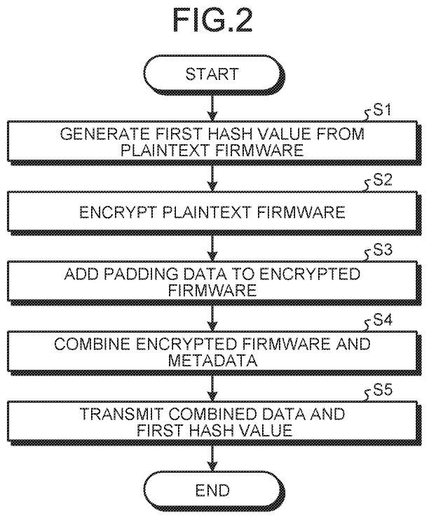

FIG. 2 is a flowchart illustrating an example of a flow of an encrypted data generation process according to the embodiment.

The first hash value generator 11 inputs the plaintext firmware 41 stored in the storage 15 into a certain hash function and performs calculation, and generates the first hash value 6 from the plaintext firmware 41 (S1).

Next, the encryptor 12 encrypts the plaintext firmware 41 with the encryption key 5 that is stored in the storage 15 (S2).

Then, the first combiner 13 determines whether the data length of the encrypted firmware 42 is a multiple of 512 bytes or not, and in the case where the data length of the encrypted firmware 42 is not a multiple of 512 bytes, the first combiner 13 adds padding data, such as “0”, to the encrypted firmware 42 (S3).

Next, the first combiner 13 combines the metadata 9 with the encrypted firmware 42 to which the padding data is added, and generates the combined data 40 (S4). In the case where the data length of the encrypted firmware 42 is a multiple of 512 bytes, the first combiner 13 does not have to add the padding data to the encrypted firmware 42. In this case, the first combiner 13 combines the metadata 9 with the encrypted firmware 42 to which the padding data is not added.

The first transmitter 14 transmits, to the signature-attached data generation server 2, the combined data 40 and the first hash value 6 in association with each other (S5).

Next, a digital signature-attached data generation process by the signature-attached data generation server 2 of the embodiment configured in the above manner will be described.

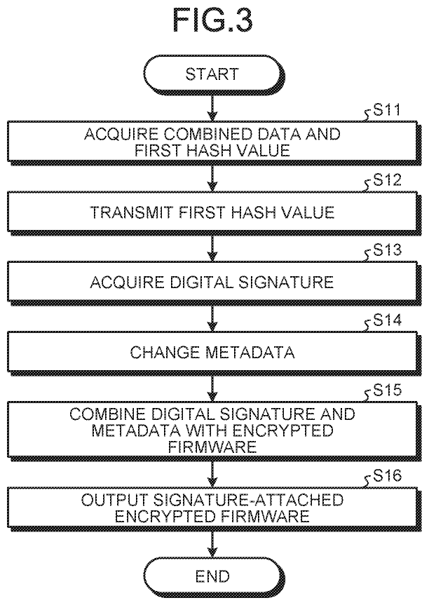

FIG. 3 is a flowchart illustrating an example of a signature-attached data generation process according to the embodiment.

The first acquisitor 21 acquires the combined data 40 including the encrypted firmware 42 and the metadata 9, and the first hash value 6 (S11).

Next, the second transmitter 22 transmits the first hash value 6 acquired by the first acquisitor 21 to the signature generation server 3 (S12).

Then, the second acquisitor 23 acquires the digital signature 8 generated based on the first hash value 6 transmitted in S12, from the signature generation server 3 (S13).

Next, the second combiner 24 changes the metadata 9 acquired by the first acquisitor 21 (S14). For example, the second combiner 24 adds, to the metadata 9, information indicating that the encrypted firmware 42 includes the digital signature 8, and information indicating description ranges of the digital signature 8 and the encrypted firmware 42 in the signature-attached encrypted firmware 43.

Next, the second combiner 24 combines the digital signature 8 and the changed metadata 9 with the encrypted firmware 42, and generates the signature-attached encrypted firmware 43 (S15).

The first outputter 25 outputs the signature-attached encrypted firmware 43 (S16). The output signature-attached encrypted firmware 43 is downloaded in the hard disk device through a network such as the Internet.

Next, a digital signature generation process by the signature generation server 3 of the embodiment configured in the above manner will be described.

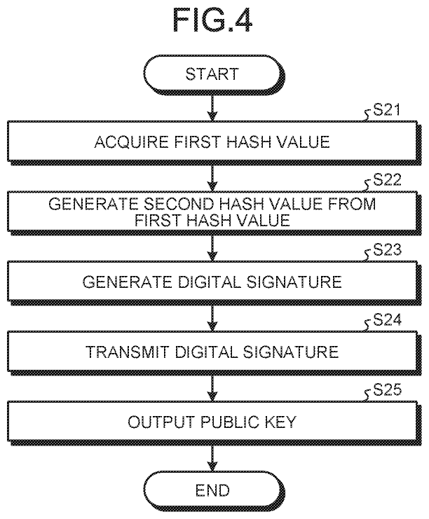

FIG. 4 is a flowchart illustrating an example of a flow of a digital signature generation process according to the embodiment. The private key 71 and the public key 72 are generated by the key generator 31 and are saved in the storage 36 before the process of the flowchart is started.

The third acquisitor 32 acquires the first hash value 6 from the signature-attached data generation server 2 (S21).

The second hash value generator 331 inputs the acquired first hash value 6 into a certain hash function and performs calculation, and generates the second hash value from the first hash value 6 (S22).

The digital signature generator 33 encrypts the second hash value generated by the second hash value generator 331, with the private key 71 stored in the storage 36, and generates the digital signature 8 for the plaintext firmware 41 (S23).

The third transmitter 34 transmits the digital signature 8 generated by the digital signature generator 33 to the signature-attached data generation server 2 (S24).

Then, the second outputter 35 outputs the public key 72 that is paired with the private key 71 used by the digital signature generator 33 in S23 to encrypt the second hash value (S25). For example, the second outputter 35 transmits the public key 72 to the hard disk device where the signature-attached encrypted firmware 43 is downloaded, through a network such as the Internet.

The hard disk device where the signature-attached encrypted firmware 43 is downloaded decrypts the digital signature 8 included in the signature-attached encrypted firmware 43 with the public key 72, and calculates the second hash value. The hard disk device also decrypts the encrypted firmware 42 included in the signature-attached encrypted firmware 43 with the encryption key 5. The hard disk device inputs the plaintext firmware 41 that is obtained by decrypting the encrypted firmware 42 into the certain hash function used by the first combiner 13, and calculates the first hash value 6. The hard disk device further inputs the first hash value 6 into the certain hash function used by the second hash value generator 331, and calculates the second hash value.

The hard disk device compares the second hash value calculated from the encrypted firmware 42 and the second hash value calculated from the digital signature 8, and if the two second hash values are the same, the hard disk device determines that the plaintext firmware 41 is not tampered with. If the two second hash values are not the same, the hard disk device determines that the plaintext firmware 41 is possibly tampered with. Such a process of determining tampering/non-tampering of the plaintext firmware 41 is performed by a boot processing program at the time of a boot process of the hard disk device, for example.

As described above, the PC 1 of the embodiment transmits, to the signature-attached data generation server 2, the first hash value 6 that is generated from the plaintext firmware 41, and the encrypted firmware 42 that is generated by encrypting the plaintext firmware 41. Accordingly, with the PC 1 of the embodiment, because transfer of the plaintext firmware 41 between devices is avoided, exposure of the plaintext firmware 41 may be prevented. Thus, the PC 1 of the embodiment can reduce risks regarding security.

For example, in a comparative example, a signature generation server uses plaintext firmware, instead of a first hash value, as an input value to generate a digital signature for the plaintext firmware. Accordingly, transfer of the plaintext firmware is sometimes performed at the time of the signature generation server acquiring the plaintext firmware from a PC or a signature-attached data generation server.

In another comparative example, even when encrypted data is used for transfer of data between a PC and a signature-attached data generation server, plaintext firmware is sometimes exposed after the encrypted data is decrypted for generation of a digital signature. For example, in the comparative example, the signature-attached data generation server decrypts encrypted firmware that is transmitted from the PC with an encryption key to obtain plaintext firmware, and transmits the plaintext firmware to a signature generation server. Accordingly, the plaintext firmware is possibly exposed on a network at the time of being transmitted between the signature-attached data generation server and the signature generation server.

In contrast, according to the embodiment, the PC 1 transmits the encrypted firmware 42 and the first hash value 6 to the signature-attached data generation server 2, instead of the plaintext firmware 41 and the encryption key 5. Thus, the PC 1 of the embodiment can prevent exposure of the plaintext firmware 41 at the time of transmission to the signature-attached data generation server 2 or the signature generation server 3.

The plaintext data of the embodiment is the plaintext firmware 41 for a hard disk device. In relation to a hard disk device, a process of checking security of the plaintext firmware 41 by the digital signature 8 is performed at the time of the boot process, and the digital signature 8 for the plaintext firmware 41 that is generated is therefore required. Furthermore, generally, a device for generating the plaintext firmware 41 (for example, the PC 1) and a device for generating the digital signature 8 and digital signature-attached data (for example, the signature generation server 3, or the signature-attached data generation server 2) are different devices. The PC 1 of the embodiment transmits the first hash value 6 and the encrypted firmware 42 obtained by encrypting the plaintext firmware 41 for a hard disk device. Thus, the PC 1 of the embodiment can prevent exposure of the plaintext firmware 41 for a hard disk device at the time of providing the digital signature 8 for the plaintext firmware 41.

The PC 1 of the embodiment encrypts the plaintext firmware 41 by the common key system. A data length (i.e., the number of digits) of an encryption key may be made shorter by the common key system than by a public key system. Thus, the PC 1 of the embodiment can prevent data capacity of the hard disk device for decrypting the encrypted firmware 42 from running short.

Furthermore, the PC 1 of the embodiment determines whether the data length of the encrypted firmware 42 is a certain data length or not, and in the case of determining that the data length of the encrypted firmware 42 is not the certain data length, the PC 1 adds padding data for filling up a difference to the certain data length to the encrypted firmware 42, and transmits the combined data 40 combining the metadata 9 including information about the encrypted firmware 42 and the encrypted firmware 42 to which the padding data is added to the signature-attached data generation server 2. Accordingly, with the PC 1 of the embodiment, the hard disk device that the encrypted firmware 42 is downloaded can read efficiently the encrypted firmware 42 in units of certain data length.

The signature generation server 3 of the embodiment generates the second hash value from the first hash value 6 that is generated from the plaintext firmware 41, by a certain hash function, and generates the digital signature 8 for the plaintext firmware 41 from the second hash value. Accordingly, the signature-attached data generation server 2 of the embodiment can generate the digital signature 8 for the plaintext firmware 41 without directly the plaintext firmware 41. Accordingly, the signature-attached data generation server 2 of the embodiment can prevent exposure of the plaintext firmware 41 at the time of generation of the digital signature 8.

The signature-attached data generation server 2 of the embodiment generates a pair of private key 71 and public key 72, encrypts the second hash value with the private key 71, and generates the digital signature 8. Furthermore, the signature-attached data generation server 2 outputs the public key 72. According to the embodiment, because the private key 71 and the public key 72 are generated in the signature-attached data generation server 2 that generates the digital signature 8, exposure of the private key 71 may be prevented. Thus, the signature-attached data generation server 2 of the embodiment can further reduce risks regarding security.

The signature-attached data generation server 2 of the embodiment acquires the digital signature 8 for the plaintext firmware 41, and the encrypted firmware 42 that is encrypted, combines the digital signature 8 and the encrypted firmware 42, and generates the signature-attached encrypted firmware 43. Accordingly, because the signature-attached data generation server 2 of the embodiment generates the signature-attached encrypted firmware 43 without decrypting the encrypted firmware 42, the signature-attached data generation server 2 of the embodiment can prevent exposure of the plaintext firmware 41.

The digital signature-attached data generation system S of the embodiment includes the PC 1, the signature-attached data generation server 2, and the signature generation server 3. The PC 1, the signature-attached data generation server 2, and the signature generation server 3 each have the configuration described above. Thus the digital signature-attached data generation system S of the embodiment can reduce exposure of the plaintext firmware 41 may be prevented, and risks regarding security.

In the embodiment, the plaintext firmware 41 is cited as an example of plaintext data, but the method of the embodiment for generating the digital signature is also applicable to other types of plaintext data.

In the embodiment, the key generator 31 generates the private key 71 and the public key 72 in advance, and stores the keys in the storage 36, but the key generator 31 may generate the private key 71 and the public key 72 at a timing of the digital signature generator 33 generating the digital signature 8.

Furthermore, the key generator 31 may generate a plurality of pairs of private key 71 and public key 72, instead of one pair of private key 71 and public key 72. In the case of adopting such a configuration, the storage 36 stores the private key 71 and the public key 72, which are paired, in association with each other in units of pairs.

The encryptor 12 of the PC 1 may encrypt the plaintext firmware 41 by a public key system instead of the common key system.

Information included in the metadata 9, the combined data 40, and the encrypted firmware 42 of the embodiment is exemplary, and is not restrictive. The combined data 40 and the encrypted firmware 42 do not have to include the metadata 9 or the padding data. The digital signature 8 may include information about an issuer of the digital signature 8, a creator of the plaintext firmware 41, and the like, in addition to the encrypted second hash value.

In the embodiment, in the case where the data length of the encrypted firmware 42 is a multiple of 512 bytes, the first combiner 13 does not have to add the padding data to the encrypted firmware 42, but in the case where the data length of the encrypted firmware 42 is a multiple of 512 bytes, padding data amounting to 512 bytes may be added to the encrypted firmware 42. Also with respect to the metadata 9, the first combiner 13 may add padding data amounting to 512 bytes, in the case where the data length is a multiple of 512 bytes.

One server may include the functions of the signature-attached data generation server 2 and the signature generation server 3. Furthermore, in the embodiment, the public key 72 is output by the signature generation server 3, but the signature-attached data generation server 2 may output the public key 72, together with the signature-attached encrypted firmware 43.

### FIRST EXAMPLE MODIFICATION

In the embodiment described above, the PC 1 transmits the combined data 40 including the metadata 9 and the encrypted firmware 42, and the first hash value 6 to the signature-attached data generation server 2, but the first hash value 6 may alternatively be included in the metadata 9. For example, the first combiner 13 generates the metadata 9 including the first hash value 6 that is generated by the first hash value generator 11, and generates the combined data 40 by combining the metadata 9 and the encrypted firmware 42. In the case of adopting such a configuration, the first hash value 6 is included in the combined data 40, and thus, the first transmitter 14 does not have to separately transmit the combined data 40 and the first hash value 6 to the signature-attached data generation server 2, and the transmission process may be efficiently performed.

### SECOND EXAMPLE MODIFICATION

The second combiner 24 of the signature-attached data generation server 2 may generate the signature-attached encrypted firmware 43 by replacing a part or all of the metadata 9 or the padding data included in the combined data 40 by the digital signature 8.

In the present example modification, the metadata 9 includes information allowing a body of the encrypted firmware 42 and the padding data to be distinguished from each other (such as information indicating description ranges of the body of the encrypted firmware 42 and the padding data in the encrypted firmware 42 to which the padding data is added). For example, the second combiner 24 specifies, based on the information included in the metadata 9, padding data that can be removed from the encrypted firmware 42 to which the padding data is added, and data that can be removed from the metadata 9, and replaces the removable pieces of data by the digital signature 8.

With the signature-attached data generation server 2 of the present example modification, instead of simply combining the digital signature 8, the encrypted firmware 42, and the metadata 9, a part or all of the metadata 9 or the padding data is replaced by the digital signature 8 to thereby reduce the amount of data of the signature-attached encrypted firmware 43.

Programs to be executed by the PC 1, the signature-attached data generation server 2, and the signature generation server 3 of the embodiment are provided being recorded in a computer-readable recording medium such as a CD-ROM, a flexible disk (FD), a CD-R, or a digital versatile disk (DVD) in a form of an installable or executable file.

The programs to be executed by the PC 1, the signature-attached data generation server 2, and the signature generation server 3 of the embodiment may be stored in a computer that is connected to a network such as the Internet, and be provided being downloaded over the network. Furthermore, the programs to be executed by the PC 1, the signature-attached data generation server 2, and the signature generation server 3 of the embodiment may be provided or distributed over the network such as the Internet. The programs to be executed by the PC 1, the signature-attached data generation server 2, and the signature generation server 3 may be provided being embedded in advance in a ROM or the like.

The programs to be executed by the PC 1, the signature-attached data generation server 2, and the signature generation server 3 are a module configuration including each unit described above (the first hash value generator, the encryptor, the first combiner, the first transmitter, the first acquisitor, the second transmitter, the second acquisitor, the second combiner, the first outputter, the key generator, the third acquisitor, the digital signature generator, the second hash value generator, the third transmitter, the second outputter), and as actual hardware, a CPU (processor) reads out the programs from the storage medium and executes the programs, and respective units described above are loaded into a main storage device, and the first hash value generator, the encryptor, the first combiner, the first transmitter, the first acquisitor, the second transmitter, the second acquisitor, the second combiner, the first outputter, the key generator, the third acquisitor, the digital signature generator, the second hash value generator, the third transmitter, and the second outputter are generated on the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An encrypted data generation device comprising:
one or more processors configured to:
generate a first hash value from plaintext data by a certain hash function;
encrypt the plaintext data;
generate encrypted data; and
transmit the first hash value and the encrypted data to an external device.

2. The encrypted data generation device according to claim 1, wherein the plaintext data is firmware for a hard disk device.

3. The encrypted data generation device according to claim 1, wherein the one or more processors
encrypt the plaintext data by a common key system.

4. The encrypted data generation device according to claim 1, wherein the one or more processors
determine whether a data length of the encrypted data is a certain data length or not, in a case where the data length of the encrypted data is not determined to be the certain data length,
add, in a case where the data length of the encrypted data is not determined to be the certain data length, padding data that fills up a difference to the certain data length to the encrypted data,
generate combined data combining metadata including information about the encrypted data, and the encrypted data, and
transmit the combined data to the external device.

5. The encrypted data generation device according to claim 4, wherein the metadata further includes the first hash value.

6. The encrypted data generation device according to claim 4, wherein the certain data length is a multiple of a size of one sector of a hard disk.

7. A digital signature generation device comprising:
one or more processors configured to:
generate a second hash value from a first hash value that is generated from plaintext data, by a certain hash function; and
generate a digital signature for the plaintext data from the second hash value.

8. The digital signature generation device according to claim 7, wherein the one or more processors
generate a pair of private key and public key,
output the public key, and
encrypt the second hash value with the private key, and generate the digital signature.

9. A digital signature-attached data generation device comprising:
one or more processors configured to:
acquire a digital signature for plaintext data, and encrypted data that is obtained by encrypting the plaintext data; and
combine the digital signature and the encrypted data, and generate digital signature-attached encrypted data.

10. The digital signature-attached data generation device according to claim 9, wherein
the encrypted data includes a body of the encrypted data and padding data that fills up a difference between a data length of the body and a predetermined data length,
the one or more processors
acquire combined data combining metadata including information about the encrypted data, and the encrypted data, and
replace a part or all of the metadata or the padding data included in the combined data by the digital signature, and generate the digital signature-attached encrypted data.

11. A digital signature-attached data generation system comprising:
an encrypted data generation device;
a digital signature-attached data generation device; and
a digital signature generation device, wherein
the encrypted data generation device includes
one or more processors
that generate a first hash value from plaintext data by a certain hash function,
encrypt the plaintext data, and generates encrypted data, and
transmit the first hash value and the encrypted data to the digital signature-attached data generation device,
the digital signature-attached data generation device includes
one or more processors
that acquire the first hash value and the encrypted data from the encrypted data generation device,
transmit the first hash value to the digital signature generation device,
acquire a digital signature for the plaintext data, from the digital signature generation device,
combine the digital signature and the encrypted data, and generate digital signature-attached encrypted data, and
the digital signature generation device includes
one or more processors
that acquire the first hash value from the digital signature-attached data generation device,
generate a second hash value from the first hash value by a certain hash function,
generate the digital signature for the plaintext data from the second hash value, and
transmit the digital signature that is generated to the digital signature-attached data generation device.

12. The digital signature-attached data generation system according to claim 11, wherein the plaintext data is firmware for a hard disk device.

13. The digital signature-attached data generation system according to claim 11, wherein the one or more processors of the encrypted data generation device encrypt the plaintext data by a common key system.

14. The digital signature-attached data generation system according to claim 11, wherein
the one or more processors of the encrypted data generation device determine whether a data length of the encrypted data is a certain data length or not,
add, in a case where the data length of the encrypted data is not determined to be the certain data length, padding data that fills up a difference to the certain data length to the encrypted data,
generate combined data combining metadata including information about the encrypted data, and the encrypted data, and
transmit the combined data to the digital signature-attached data generation device.

15. The digital signature-attached data generation system according to claim 14, wherein the metadata further includes the first hash value.

16. The digital signature-attached data generation system according to claim 14, wherein the certain data length is a multiple of a size of one sector of a hard disk.

17. The digital signature-attached data generation system according to claim 11, wherein
the one or more processors of the digital signature generation device
generate a pair of private key and public key,
output the public key,
encrypt the second hash value with the private key, and
generate the digital signature.

18. The digital signature-attached data generation system according to claim 11, wherein
the encrypted data includes a body of the encrypted data and padding data that fills up a difference between a data length of the body and a certain data length,
the one or more processors of a digital signature-attached data generation device
acquire combined data combining metadata including information about the encrypted data, and the encrypted data,
replace a part or all of the metadata or the padding data included in the combined data by the digital signature, and
generate the digital signature-attached encrypted data.
